(19) United States
(12) Patent Application Publication
(10) Pub. No.: US 2005/0284385 A1
(43) Pub. Date: Dec. 29, 2005

(54) Portable deer feeder

(76) Inventor: Robert Quinn, Haines City, FL (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/122,737

(22) Filed: May 5, 2005

Related U.S. Application Data
(60) Provisional application No. 60/568,309, filed on May 5, 2004.
(60) Provisional application No. 60/587,483, filed on Jul. 13, 2004.

(51) Int. Cl. A01K 5/01

(52) U.S. Cl. 119/52.1

(57) ABSTRACT

A mechanism for feeding deer is disclosed. The invention comprises an annular feed trough for holding food; food storage means above the feed trough for replenishing the feed trough by gravity; an electrified standpipe comprising a plurality of legs for vertically elevating the feed trough; and a plurality of electrodes forming an electrode collar with a plurality of radially extending pins to provide an electric shock to game birds which attempt to feed and a switch for activating the electrodes.

### CLAIM OF PRIORITY

This application derives priority for U.S. Ser. No. 60/568,309, filed May 5, 2004 and 60/587,483 filed Jul. 13, 2004, both of which are incorporated herein by reference.

### FIELD OF THE INVENTION

The present invention is directed to the field of deer feeders. In particular, the present invention is directed to electrified, elevated, varmint-proof deer feeders.

### BACKGROUND OF THE INVENTION

The purpose of such deer feeders is to provide a feeding apparatus which enables a hunter to attract game into a designated area. One of the main problems with prior art is often it is that they enable other animals and varmints such as raccoons and squirrels to eat the food set out for the game. These varmints are frequently destructive as well.

There have been a number of patents issued to the area of deer feeders. U.S. Design Pat. No. 492,070 to Evans dated Jun. 22, 2004 discloses an ornamental design for a deer feeder. U.S. Design Pat. No. 477,440 to Ansaldo, dated Jul. 15, 2003 discloses an ornamental design for a deer feeder.

U.S. Pat. No. 6,481,374 to Lillig dated Nov. 19, 2004 discloses a deer feeder adapted for hanging in a tree is provided. The feeder includes an upright tubular feed reservoir. A feeding port angles upwardly from and communicates with the feed reservoir proximate its bottom end. In a first embodiment of the feeder, a flexible support member such as a chain is connected to the reservoir proximate its top end and so as to be engageable with the tree to suspend the feeder therefrom and a cleat extends outwardly from the feed reservoir and engages the tree trunk in order to stabilize the feeder relative to the tree. In a second embodiment, the exterior surface of the feeder is corrugated so as to include a plurality of transverse ridges separated by grooves. The feeder is connected to a tree trunk by flexible securement members which encircle the feeder and engage the grooves on the exterior surface.

U.S. Pat. No. 6,199,509 to Mostyn, et al., dated Mar. 13, 2001, discloses a gravity deer feeder with baffles, comprising a hopper with an upper portion and a lower portion; the lower portion of the hopper includes a domed base to the interior of the hopper and also includes at least one feeding port to provide a passage for feed from the interior to the exterior. The hopper also includes one or more baffles projecting from the interior wall of the hopper that act to support at least some of the feed stored within the hopper.

U.S. Pat. No. 5,143,022 to Fore, dated Sep. 1, 1992, discloses a feeding device for deer, antelope, and other animals by releasing a liquid feedstock such as molasses whenever part of the device is licked by the animal.

U.S. Pat. No. 4,945,859 to Churchwell, dated Aug. 7, 1990, discloses a feeder which includes a bucket and a conical section extending from the lower end of the bucket to a discharge opening. A distributing assembly predictably meters feed from the interior of the bucket and conical section either by the action of wind against a sphere or by an electrical feeding assembly. The distributing assembly includes a plate, a rod pivoted from the plate and a disc mounted on a rod. Posts on the disc interact with orifices on the plate to meter the feed.

U.S. Patent Application No. 20020185077 to Cornell, dated Dec. 12, 2002 discloses a device which attracts deer with the sound of a deer feeder distributing feed.

U.S. Patent Application No. 20020185075 to Glover, dated Dec. 12, 2002, discloses a device is shown for filling a wildlife feeder with material. The device has a primary conduit and a pressure source connected to the primary conduit for propelling air through the primary conduit. A secondary conduit extends from the primary conduit such that at least a portion of the air flowing though the primary conduit flows through the secondary conduit and into a primary receptacle wherein a pressure is created inside the primary receptacle that is equal to or greater than the pressure in the primary conduit. The primary receptacle has a sealable feed port for receiving material to be conveyed and an outlet connected to the primary conduit down stream from the pressure source and the secondary conduit such that material can pass from the primary receptacle by gravity flow through the outlet and become entrained in the movement of the air created by the pressure source and into a secondary receptacle which is located at an elevated location.

While there have been a sustained number of prior deer feeders, none of the deer feeders have adequately addressed the problem of deterring other animals and varmints from feeding in the food. None have adequately sheltered the food. None have adequately combined these features with transportability and ease of use.

It is an object of the present invention to provide a deer feeding system which includes electrodes for deterring squirrels and other varmint animals.

It is another object of the present invention to provide a system which can feed either a deer or a turkey while deterring other animals and varmints.

It is an object of the present invention to provide feed which will be consumed by target animals including deer or large game birds such as turkey.

It is still a further object of the invention to provide a system in which feed is weather shielded and available to deer and turkey.

It is still a further object of the present invention to provide a feeder having no moving parts and which includes a battery pack.

It is a further object of the present invention to provide a feeder which includes a novel turkey collar mechanism to prevent turkeys from feeding.

These and other objects of the present invention will become apparent from the detailed description which follows.

### SUMMARY OF THE INVENTION

In accordance with the present invention, a mechanism for feeding deer comprising: a feed trough; a standpipe for elevating the feed trough; and a plurality of electrodes proximate to the trough for producing an electric shock to a varmint which attempts to reach the feed through.

In a further embodiment, the invention is a mechanism for feeding deer comprising an annular feed trough; an electrified standpipe for vertically elevating the feed trough a plurality of electrodes forming an electrode collar surrounding the feed trough, to provide a electric shock to large game birds such as turkey; and a switch for activating the electrodes.

In still a further embodiment the invention is a mechanism for feeding deer comprising: an annular feed trough for holding food; food storage means above the feed trough for replenishing the feed trough by gravity; an electrified standpipe comprising a plurality of legs for vertically elevating the feed trough; and a plurality of electrodes forming an electrode collar with a plurality of radially extending pins to provide an electric shock to game birds which attempt to feed; and a switch for activating the electrodes.

In still a further embodiment, the invention is a mechanism for feeding deer comprising an annular feed trough; a standpipe for vertically elevating the feed trough a plurality of electrodes forming an electrode collar surrounding the feed trough to provide a electric shock to turkeys; a switch for activating the electrodes; and a power supply such as a battery pack to power the electrodes.

### BRIEF DESCRIPTION OF THE FIGURES FIG. 1 is a perspective view of the present invention.

FIG. 2 is a side perspective view of a first embodiment of deer feeder of the present invention.

FIG. 3 is a further side perspective view of a deer feeder with turkey blocking idea.

FIGS. 4 and 4a are a side view of the embodiment with turkey blocking collar.

FIGS. 5 and 6 are respective upright and underside views of the embodiment with turkey block mounting apparatus.

FIGS. 7 and 8 are another embodiment of the invention.

### DESCRIPTION OF THE PREFERRED EMBODIMENT

The present invention is described with reference to the enclosed Figures wherein the same numbers are utilized. In a most preferred embodiment, the present invention is broadly directed to an improved elevated deer feeder 10. Referring to FIG. 1, the present invention is shown in detail. The invention comprises a deer feeder 10 having a feed plate 12. The plate 12 defines a feed trough which holds and stores food such as nuts, grain or acorns.

The invention is preferably elevated by a single or multiprong standpipe 15. The standpipe 15 preferably is surrounded by electrodes which emit an electric charge when touched by the paws and/or mouths of a varmint. An annular rain hood 19 overhangs the feed trough and protects the food. The system includes a battery storage compartment 31 for holding a battery or power pack.

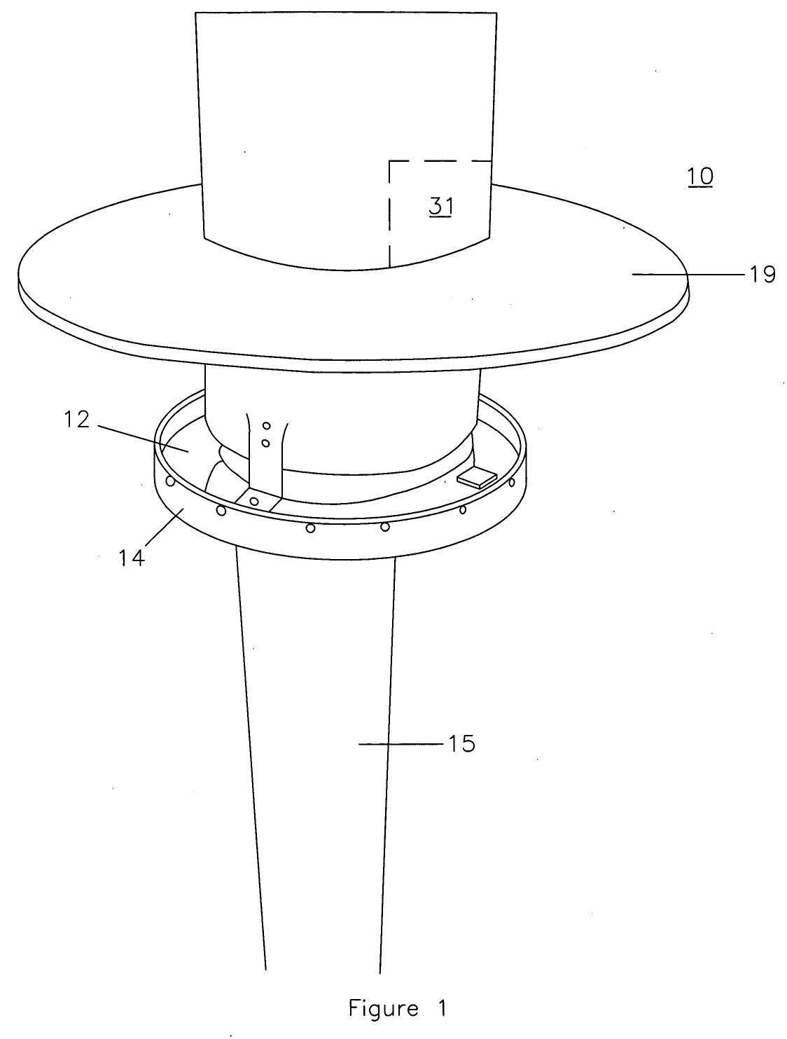

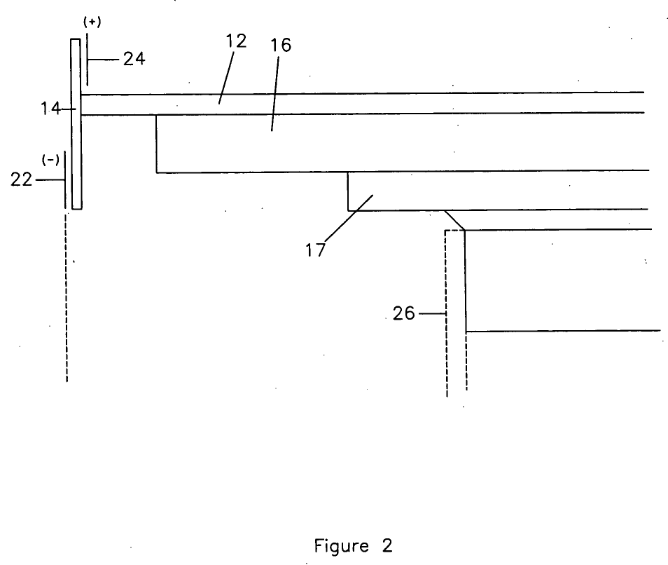

Referring to FIG. 2, a cross section of a feed plate 12 in accordance with the present invention is now shown. The feed plate 12 and an insulator 14 are made of high density polyethylene and are welded or affixed together. In one embodiment, an underlying feed plate support 16 is added and constructed from a material such as polymer or plywood.

Although the thickness of these materials may vary with the overall size of the feeder 10, in a most preferred embodiment the invention preferably has a has a 0.25 inch thick feed plate 12 and an 0.125 inch thick insulator 14. Small varmints such as squirrels are too small for their hind feed to reach under and kick off of the negative foot plate 26 of the standpipe 15 and would instead kick off of the non-electrified bottom of the feed plate 12, the feed plate support or an associated PVC flange 17.

To prevent access to varmints, then, a three inch vertical downward extension of a palm electrode 22 prevents the varmint's hind feet from reaching non-electrified surfaces. Finger tip electrode 24 is situated on the opposite side of the insulator 14. Both electrodes 22 and 24 are directly wired and routed through a ¼-inch groove cut into the top surface of the feed plate support into the battery compartment 31. As noted the electrodes of the standpipe are similarly charged.

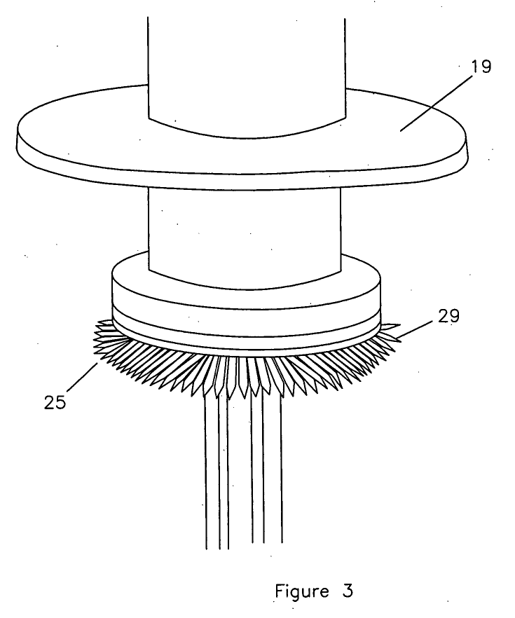

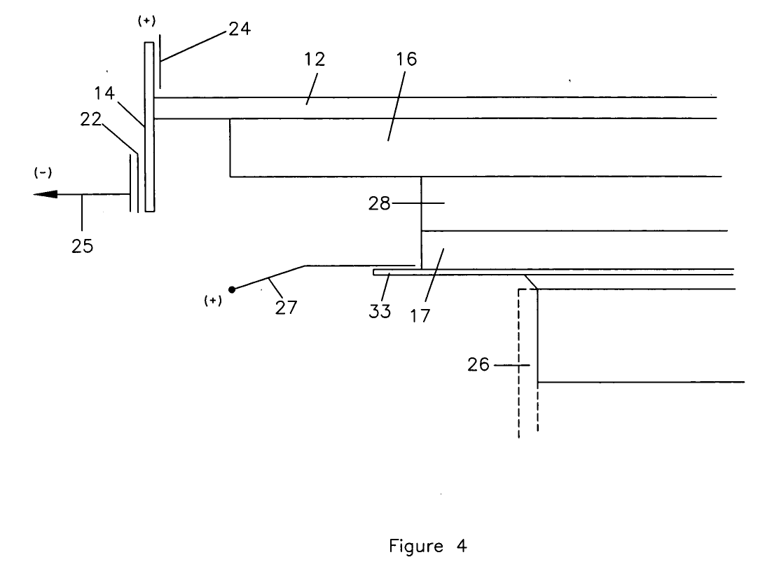

Referring to FIGS. 3, 4 and 4a, an optional feature of the invention is the provision of a mechanism to block large game birds such as wild turkeys from feeding from the trough 12. This is accomplished by the inclusion a novel turkey block collar 25. In one embodiment, the collar comprises a copper band attached to electrode 22. The collar includes a plurality of radially extending pins 25 soldered into it and which extend the voltage of electrode 22 outward. The bird gets a shock by completing a circuit between electrodes 22 and 24 as it attempts to feed as shown in FIG. 4a.

As above in FIG. 4, this embodiment includes the feed pate 12, feed plate support, 16 and electrodes 22 and 24. FIG. 4 is a cross section view of a feed plate 12 modified to accommodate the turkey block collar. Because the pins 25 of the turkey block collar become a new grasp point for the varmints, thus allowing the varmint to access the feed plate, a further electrode 27, referred to as a turkey block collar footplate, is added and is shown mounted onto the footplate-insulating mount 33. In this embodiment the additional electrode 27 is added because the turkey blocking collar would become a new grasps point for a varmint. In substance, this creates a potential between 25 and 27 which gives a climbing varmint a shock.

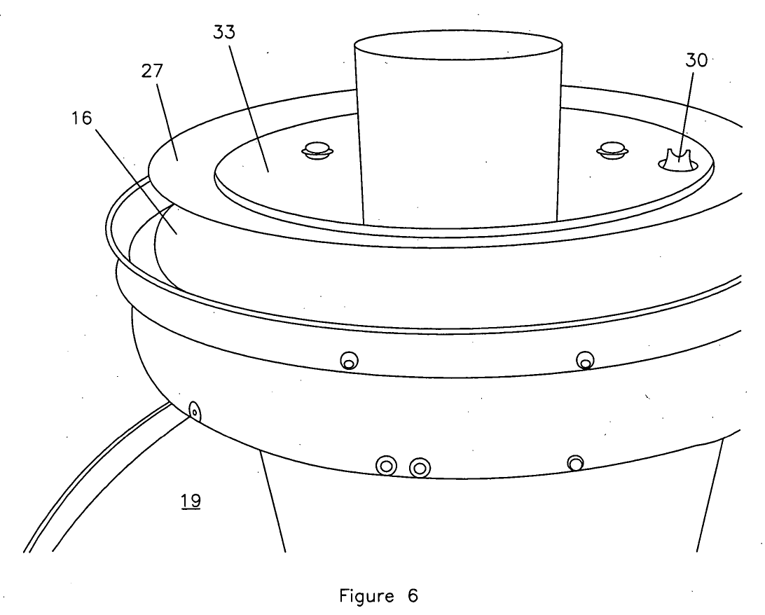

A turkey block collar flange spacer 28 is also added in this embodiment to accommodate proper spacing. Because turkeys, as well as deer may be the desired game, the copper collar 29 is intended to be added to an existing feeder with a switch 30, shown in FIG. 6. The switch reverses the polarity of the foot plate between positive and negative, as the turkey block collar is added or removed from the feeder. This new electrode is switched to a positive charge only when a turkey block collar is attached and desired to be activated.

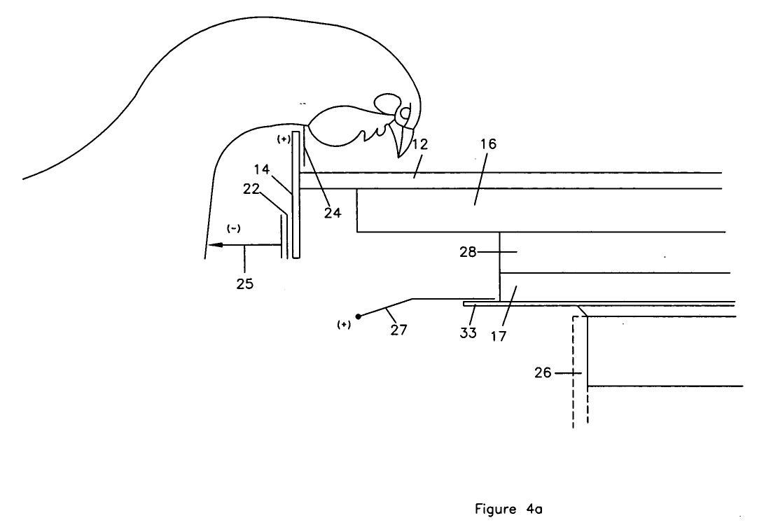

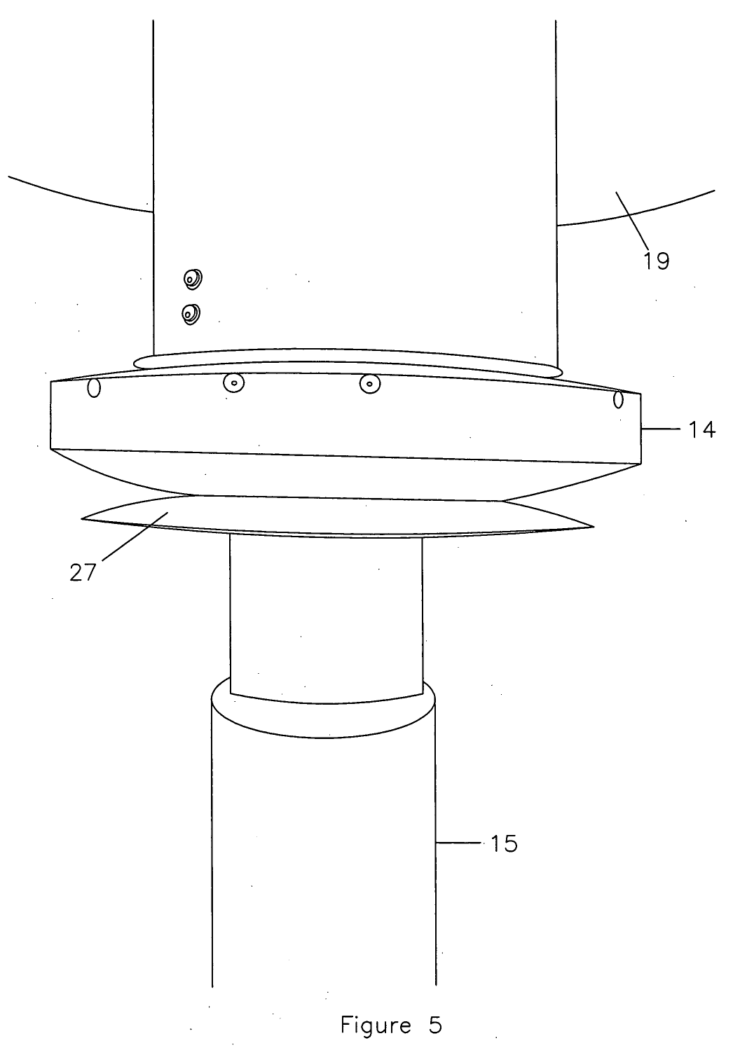

FIGS. 5 and 6 show a side view of a feeder modified for a turkey block collar and specifically shows the bottom view of a feed plate assembly with the turkey block collar foot plate installed. (FIG. 6 is an underside view). As noted, the copper collar itself will preferably be sold as an optional accessory to the basic feeder although the foot plate, its insulating mount, the switch and flange spacer can be part of a basic production unit.

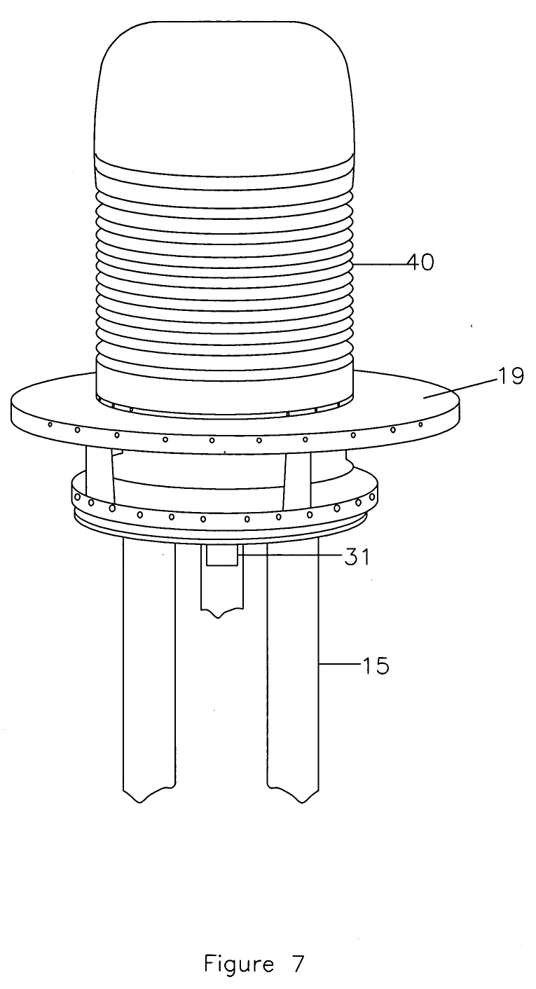

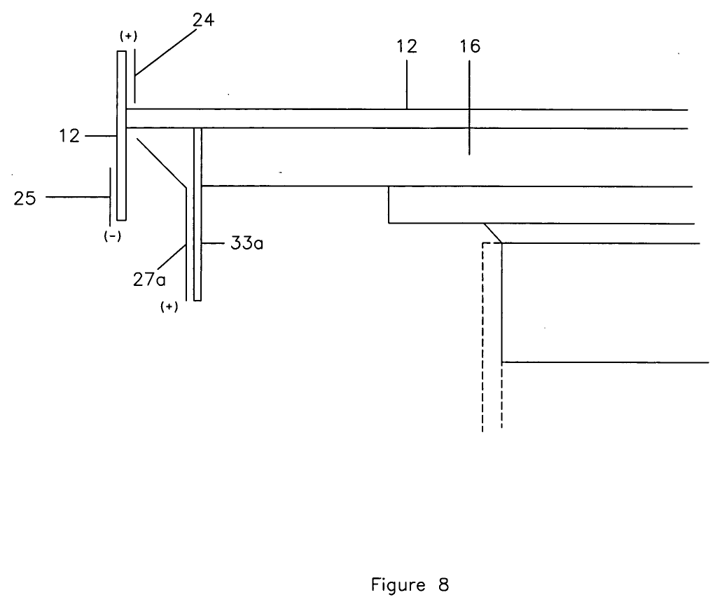

FIG. 7 illustrates a further embodiment. In this embodiment, a large gallon food storage means 40 is supported by three electrified standpipes 15 rather than just one and the battery compartment 31 has been moved to a separate compartment in the center where access to the batteries is more readily available on such a large unit. As shown in FIG. 8, an alternate designed turkey block collar footplate 27a and its insulating mount 33a is shown.

The footplate is made out of soft metal bent at 45 degrees which bent portion is sliced every ¾-inch or so to accommodate forming around the insulating footplate mount to which it attaches. This style of a footplate is much more practical for a large 28-inch diameter feed plate than is the pan style footplate used in smaller units.

The present invention suggests a plurality of additional embodiments. In further embodiments, the feeder of the present invention can be used to feed wood ducks. In such an embodiment, the electrified standpipe 15 is elevated so that it supports a feeder far above the reach of both the turkeys and the deer. Since the electrified standpipe 15 prevents all varmints from climbing up the standpipe, there is no need to electrify the feed plate of the feeder placed on top and the wood ducks simply feed from it.

The electrified standpipe can protect a wood duck nesting box from attack by the varmints when it is placed on top of a similar electrified standpipe 15. It is to be noted that the extended electrified standpipe 15 will support and protect any type of birdhouse/nesting box from varmints. It also allows for the nesting box to be safely positioned at eye level for better observation.

In still a further embodiment, an extended or longer electrified standpipe 15 supports a traditional spinner type feeder which may be modified to sit atop the electrified standpipe just as the wood duck feeder and wood duck nesting box mentioned above. Such suspension can be achieved by using either single or multiple standpipes.

Longer standpipes can also be used to replace the corner posts of the remote feeding sheds that cover open feeding troughs as the deer and cattle are currently being fed now in some places. These electrified corner post standpipes will prevent varmints from climbing up the posts and dropping down into open feeding troughs which can also be built incorporating the same technology as the present electrified feed plate, and which can also be supported by one or more electrified standpipes. These electrified open feed troughs can have a variety of geometric shapes such as either round, rectangular, square, etc., which are similarly supported by more than one standpipe.

The present invention has been described with reference to the enclosed detailed description. The true nature and scope of the invention is to be determined with reference to the claims appended hereto.

1. A mechanism for feeding deer comprising
A feed trough;
a standpipe for elevating the feed trough; and
a plurality of electrodes proximate to the trough for producing an electric shock to a varmint which attempts to reach the feed trough.

2. The mechanism for feeding deer of claim 1 further comprising at least one electrode on said standpipe.

3. The mechanism for feeding deer of claim 1 further comprising a hood to shelter the feed trough.

4. A mechanism for feeding deer comprising
an annular feed trough;
an electrified standpipe for vertically elevating the feed trough;
a plurality of electrodes forming an electrode collar surrounding the feed trough to provide an electric shock to large game birds such as turkey; and
a switch for activating the electrodes.

5. The mechanism for feeding deer of claim 1 further comprising a battery pack to power the electrodes.

6. A mechanism for feeding deer comprising
an annular feed trough for holding food;
food storage means above the feed trough for replenishing the feed trough by gravity;
an electrified standpipe comprising a plurality of legs for vertically elevating the feed trough;
a plurality of electrodes forming an electrode collar with a plurality of radially extending pins to provide an electric shock to game birds which attempt to feed;
and a switch for activating the electrodes.

7. A mechanism for feeding deer comprising
an annular feed trough;
a standpipe for vertically elevating the feed trough;
a plurality of electrodes forming an electrode collar surrounding the feed trough to provide a electric shock to turkeys;
a switch for activating the electrodes; and
a power supply to power the electrodes.
